(19) United States
(12) Patent Application Publication
(10) Pub. No.: US 2020/0034041 A1
(43) Pub. Date: Jan. 30, 2020

(54) UTILIZING GROUPS OF DATA PROTECTION POLICIES THAT ARE ASSIGNABLE TO STORAGE OBJECTS

(71) Applicant: EMC IP Holding Company LLC, Hopkinton, MA (US)

(72) Inventors: Tianming Zhang, Hopkinton, MA (US); Girish Sheelvant, Hopkinton, MA (US); Qi Jin, Sudbury, MA (US); Nagasimha Haravu, Apex, NC (US); Michael Zeldich, Newton, MA (US); Sathish Janamanchi, Shrewsbury, MA (US)

(21) Appl. No.: 16/048,489

(22) Filed: Jul. 30, 2018

(51) Int. Cl. G06F 3/06

(52) U.S. Cl. CPC G06F 3/065; G06F 3/067; G06F 3/0619

(57) ABSTRACT

A technique utilizes a group of data protection policies within data storage equipment. The technique involves providing, by the data storage equipment, access to individually invocable data protection services. The data storage equipment is constructed and arranged to invoke each individually invocable data protection service in response to user entrance of a respective data protection rule to protect data within a storage object. The technique further involves forming, by the data storage equipment, a policy group from multiple data protection rules. The technique further involves assigning, by the data storage equipment, the policy group to a set of storage objects to protect data within the set of storage objects. Such a technique enables assignment of multiple and different data protection rules to a storage object all at once. Moreover, if the policy group is modified, the modification may be applied to all storage objects at the same time.

### BACKGROUND

Data storage systems save and retrieve host data on behalf of host computers. Some data storage systems store host data in volumes via block-based operations. Other data storage systems store host data in files via file-based operations.

Some data storage systems periodically create local snapshots of host data. Until the local snapshots are deleted, the data storage systems are able to retrieve that host data from the local snapshots.

Additionally, some local data storage systems replicate host data to remote data storage systems. In such a situation, if a host computer loses access to a local data storage system, the host computer can access the host data from a replica (e.g., a replicated volume or file system) on a remote data storage system.

### SUMMARY

Unfortunately, there are deficiencies to the above described conventional data storage systems that create local snapshots of host data and/or replicate host data to remote data storage systems. For example, human system administrators find it burdensome to individually configure a snapshot schedule and/or a replication session for each volume or for each file system. Such manual operations may be tedious, time consuming, and error prone.

Alternatively, human system administrators may write command scripts and then execute the command scripts to configure volumes and file systems for snapshotting and/or replication in a more automated manner. However, such command script writing imposes extra skill requirements on the human system administrators (e.g., to write the scripts, to debug the scripts, to maintain the scripts, etc.). Furthermore, even if the human system administrators utilize command scripts to initially configure volumes and file systems for snapshotting and/or replication, the human system administrators will likely manually re-configure a snapshot schedule or a replication session for each volume or for each file system when making adjustments to the snapshotting and/or replication sessions, or alternatively write and execute new command scripts to carry out the adjustments. In contrast to the above-described a conventional data storage system which imposes tedious and time consuming burdens on a human system administrator to individually configure a snapshot schedule or a replication session for each volume or for each file system, improved techniques utilize groups of data protection policies (or rules) that are assignable to storage objects (e.g., logical units of storage or LUNs, file systems, etc.). In particular, a user can simply assign a policy group to each storage object. The policy group may include a variety of data protection policies such as one or more snapshot rules and one or more replication rules. Accordingly, the user is able to impose an entire group of data protection policies on each storage object all at once. Moreover, the user may change a policy or policies within a policy group that is assigned to multiple storage objects and thus adjust data protection policies for the multiple storage objects all at once. As a result, there is less time and effort imposed on the user compared to a human system administrator's conventional task of manually configuring each volume or file system individually. Furthermore, there is no special script writing skills required by the user thus making the user's job less complicated and less prone to error.

One embodiment is directed to a method of utilizing a group of data protection policies within data storage equipment. The method includes providing, by the data storage equipment, access to individually invocable data protection services. The data storage equipment is constructed and arranged to individually invoke each individually invocable data protection service in response to user entrance of a respective data protection rule to protect data within a storage object. The method further includes forming, by the data storage equipment, a policy group from multiple data protection rules. The method further includes assigning, by the data storage equipment, the policy group to a set of storage objects to protect data within the set of storage objects.

In some arrangements, the policy group identifies different data protection rules. Additionally, assigning the policy group to the set of storage objects includes applying each of the different data protection rules identified by the policy group to a particular storage object.

In some arrangements, applying each of the different data protection rules identified by the policy group includes applying multiple snapshot rules to protect data of the particular storage object locally. Each of the multiple snapshot rules specifies a different snapshot creation schedule to routinely create snapshots of the particular storage object on a local data storage array.

In some arrangements, applying each of the different data protection rules identified by the policy group includes applying multiple replication rules to protect data of the particular storage object remotely. Each of the multiple replication rules specifies different replication criteria to replicate a storage object to a remote data storage array that is different from the local data storage array

In some arrangements, applying at least one snapshot rule to protect data of the particular storage object locally includes invoking a first snapshot rule to create a first series of snapshots of the particular storage object on the local data storage array, and invoking a second snapshot rule to create a second series of snapshots of the particular storage object on the local data storage array.

In some arrangements, applying at least one replication rule to protect data of the particular storage object remotely includes invoking a first replication rule to replicate the particular storage object to a first remote data storage array, and invoking a second replication rule to replicate the particular storage object to a second remote data storage array that is different from the first remote data storage array.

In some arrangements, the policy group identifies different data protection rules. Additionally, assigning the policy group to the set of storage objects includes applying each of the different data protection rules identified by the policy group to a first storage object residing in non-volatile memory of a local data storage array and a second storage object residing in the non-volatile memory of the local data storage array. The first storage object is different from the second storage object.

In some arrangements, applying each of the different data protection rules to the first storage object and the second storage object includes, in response to a first user command, applying each of the different data protection rules to the first storage object during a first time period to protect data of the first storage object locally and remotely during the first time period. Additionally, applying includes, after the first time period, receiving a second user command and, after the first time period and in response to the second user command, applying each of the different data protection rules to the second storage object during a second time period that is after the first time period to protect data of the second storage object locally and remotely during the second time period, the different data protection rules continuing to be applied to the first storage object during the second time period to protect data of the first storage object locally and remotely during the second time period.

In some arrangements, the local data storage array is constructed and arranged to process block-based input/output (I/O) requests on behalf of a set of host computers. Additionally, the first storage object is a first logical unit of storage (LUN) that stores host data based on the block-based I/O requests, and the second storage object is a second LUN that stores host data based on the block-based I/O requests. The second LUN is different from the first LUN.

In some arrangements, the local data storage array is constructed and arranged to process file-based input/output (I/O) requests on behalf of a set of host computers. Furthermore, the first storage object is a first file system that stores host data based on the file-based I/O requests, and the second storage object is a second file system that stores host data based on the file-based I/O requests. The second file system is different from the first file system.

In some arrangements, the method further includes, after the second time period, receiving a third user command and, in response to the third user command, making a data protection rule modification to the policy group.

In some arrangements, making the data protection rule modification to the policy group includes changing at least one data protection rule identified by the policy group while the policy group is being applied to the first storage object and the second storage object.

In some arrangements, the method further includes, in response to changing a particular data protection rule identified by the policy group while the policy group is being applied to the first storage object and the second storage object, immediately applying the changed particular data protection rule to the first storage object and the second storage object.

In some arrangements, the method further includes, in response to changing a particular data protection rule identified by the policy group while the policy group is being applied to the first storage object and the second storage object, immediately prompting a user for permission to apply the changed particular data protection rule to the first storage object and the second storage object.

In some arrangements, an original policy group is assigned to the first storage object and the second storage object during the second time period. Additionally, the method further includes, after the second time period, receiving a third user command and, in response to the third user command, assigning a new policy group to one of the first storage object and the second storage object in place of the original policy group while the original policy group remains assigned to the other of the first storage object and the second storage object. The original policy group and the new policy group differ in at least one data protection rule.

In some arrangements, the method further includes, after the second time period, receiving a third user command and, in response to the third user command, accessing data that was saved (i.e., retrieving data that was protected) in response to application of the policy group to the first storage object and the second storage object.

Another embodiment is directed to data storage equipment which includes memory and control circuitry coupled to the memory. The memory stores instructions which, when carried out by the control circuitry, cause the control circuitry to:
(A) provide access to individually invocable data protection services, the data storage equipment being constructed and arranged to individually invoke each individually invocable data protection service to protect data within a storage object via a respective data protection rule,
(B) form a policy group from multiple data protection rules, and
(C) assign the policy group to a set of storage objects to protect data within the set of storage objects.

Yet another embodiment is directed to a computer program product having a non-transitory computer readable medium which stores a set of instructions to utilize a group of data protection policies within data storage equipment. The set of instructions, when carried out by the data storage equipment, causes the data storage equipment to perform a method of:
(A) providing access to individually invocable data protection services, the data storage equipment being constructed and arranged to individually invoke each individually invocable data protection service to protect data within a storage object via a respective data protection rule;
(B) forming a policy group from multiple data protection rules; and
(C) assigning the policy group to a set of storage objects to protect data within the set of storage objects.

It should be understood that, in the cloud context, at least some of electronic circuitry is formed by remote computer resources distributed over a network. Such an electronic environment is capable of providing certain advantages such as high availability and data protection, transparent operation and enhanced security, big data analysis, etc.

Other embodiments are directed to electronic systems and apparatus, processing circuits, computer program products, and so on. Some embodiments are directed to various methods, electronic components and circuitry which are involved in utilizing predefined groups of data protection policies that can be assigned to individual storage objects.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a block diagram of a data storage environment which utilizes groups of data protection policies that can be assigned to individual storage objects.

FIG. 2 is a block diagram of certain data storage equipment of the data storage environment of FIG. 1.

FIG. 3 is a block diagram illustrating particular details of an example situation.

FIG. 4 is a block diagram illustrating further details of the example situation.

FIG. 5 is a block diagram illustrating details of the example situation when a policy group is assigned to a new storage object.

FIG. 6 is a block diagram illustrating details of the example situation when a modification is made to a policy group.

FIG. 7 is a flowchart of a procedure which is performed by the data storage equipment of FIG. 2.

### DETAILED DESCRIPTION

An improved technique is directed to utilizing groups of data protection policies (or rules) that are assignable to storage objects (e.g., logical units of storage or LUNs, file systems, etc.). In particular, a user can simply assign a policy group to each storage object. The policy group may include different data protection policies such as one or more snapshot rules and one or more replication rules. Accordingly, the user is able to impose an entire group of data protection policies on each storage object all at once. Moreover, the user may change any rule or rules within a policy group that is assigned to multiple storage objects and thus adjust data protection policies for the multiple storage objects all at once. Accordingly, there is less time and effort imposed on the user compared to a human system administrator's conventional task of manually configuring data protection for each volume or file system individually. Furthermore, there is no special script writing skills required by the user thus making the user's job less complicated and less prone to error.

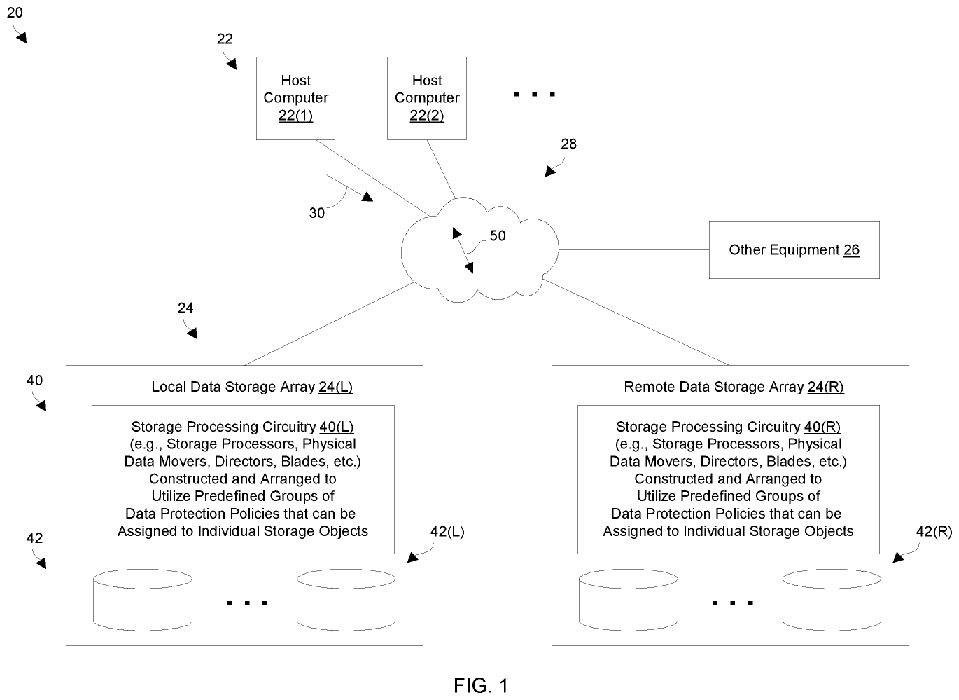

FIG. 1 shows a data storage environment 20 having equipment that utilizes groups of data protection policies that can be assigned to individual storage objects. The data storage environment 20 includes host computers 22(1), 22(2), . . . (collectively, host computers 22), a local data storage array 24(L) and a remote data storage array 24(R) (collectively, data storage arrays 24), other equipment 26, and a communications medium 28.

Each host computer 22 is constructed and arranged to perform useful work while storing host data 30 within, and loading host data 30 from the data storage arrays 24. For example, a host computer 22 may operate as a web server, a database server, a file server, an email server, an enterprise server, and so on, which provides I/O requests (e.g., small computer system interface or SCSI commands, file access commands, combinations thereof, etc.) to the data storage arrays 24 to store host data 30 in and read host data 30 from the data storage arrays 24.

Each data storage array 24 is constructed and arranged to perform data storage operations on behalf of one or more of the host computers 22. To this end, each data storage array 24 includes storage processing circuitry 40 to carry out the data storage operations, and physical storage devices 42 to store the host data 30 in a non-volatile or persistent manner. The storage processing circuitry 40 may include one or more physical storage processors, data movers, director boards, blades, I/O modules, storage drive controllers, switches, combinations thereof, and so on. The physical storage devices 42 may include solid state devices (SSDs), hard disk drives (HDDs), combinations thereof, etc.

As shown in FIG. 1, the local data storage array 24(L) includes storage processing circuitry 40(L) and storage devices 42(L). Likewise, the remote data storage array 24(R) includes storage processing circuitry 40(R) and storage devices 42(R). It should be understood that the terms “local” and “remote” are provided to indicate that the different data storage arrays 24(L), 24(R) are separated from each other and reside in different locations, e.g., on different electrical services, in different buildings, on different campuses, in different cities, in different states, on different coasts, etc.

The other equipment 26 represents other circuitry within the data storage environment 20 such as user devices, monitoring/administrative circuitry, appliances, other data storage arrays (e.g., downstream replication sites), and so on. Such other equipment 26 may or may not be part of the critical data storage path.

The communications medium 28 is constructed and arranged to connect the various components of the data storage environment 20 together to enable these components to exchange electronic signals 50 (e.g., see the double arrow 50). At least a portion of the communications medium 28 is illustrated as a cloud to indicate that the communications medium 28 is capable of having a variety of different topologies including backbone, hub-and-spoke, loop, irregular, combinations thereof, and so on. Along these lines, the communications medium 28 may include copper-based data communications devices and cabling, fiber optic devices and cabling, wireless devices, combinations thereof, etc. Furthermore, the communications medium 28 is capable of supporting SAN-based communications, LAN-based communications, cellular communications, combinations thereof, etc.

During operation, the storage processing circuitry 40 of each data storage array 24 receives I/O requests from the host computers 22, and processes the I/O requests by storing host data 30 within the local storage devices 42 of that data storage array 24 and loading host data 30 from the local storage devices 42 of that data storage array 24 on behalf of the host computers 22. It should be understood that the storage devices 42 may be arranged in a variety of configurations to robustly and reliably store the host data 30 (e.g., as RAID groups, tiered storage, log-based storage, combinations thereof, etc.). Moreover, the data storage array 24 stores the host data 30 in one or more storage objects such as volumes, logical units of storage (LUNs), consistency groups, virtual volumes, files, file systems, volumes within files, file systems within volumes, combinations thereof, and so on.

Furthermore, the data storage arrays 24 may provide a variety of data protection services to prevent data loss. In particular, each data storage array 24 supports snapshots for local data protection (e.g., to protect against a corrupted data block or file) and replication for remote data protection (e.g., to protect against a larger loss such as loss of access to that data storage array 24). Other data protection services are suitable for use as well such as RAID, mirroring, local and/or remote backups, local and/or remote archiving, and so on.

The various data protection services are invocable via user entrance of respective data protection commands. Such a data protection command may specify an individual data protection service or a group of data protection services to be applied to a particular storage object.

In connection with snapshots, a user of a data storage array 24 may create one or more snapshot rules and apply each snapshot rule to a storage object. Snapshot rules are used for local data protection. Various types of snapshot rules may be supported such as “interval” or “time of day”. Other time criteria are suitable for use as well.

It should be understood that, to apply a particular snapshot rule to a particular storage object, the data storage array 24 generates an association between the snapshot rule and the storage object. In some arrangements, the association includes a snapshot rule identifier that uniquely identifies the snapshot rule among other snapshot rules, a storage object identifier that uniquely identifies the storage object among other storage objects, and code that specifies the particular details of the snapshot rule. Such an association may be implemented in the form of a data structure, a database entry, an instance, combinations thereof, and so on.

Provided below is a suitable snapshot rule definition for each data storage array 24. Included are snapshot rule properties and supported snapshot operations such as creation, modification, and deletion.

snap_rule_instance{

| | |
|---|---|
| description: | Snap rule instance. |
| Id | string |
| | example: a9c64b58-59a5-45cd-80ed-92a4545fd080 |
| | Snapshot rule identifier. |
| Name | string |
| | example: Hourly snap rule |
| | Snapshot rule name. |
| Interval | SnapRuleIntervalEnuminteger |
| | example: 1 |
| | Interval between snaps, in minutes. Only one of |
| | interval and time of day can be set. Setting one |
| | will unset the other. |
| time_of_day | string($timestamp) |
| | example: 13:30 |
| | Time of the day to take a daily snap, with format |
| | “hh:mm” in 24 hour time format. |
| | Only one of interval and time_of_day can be set. |
| days_of_week | Days of the week on which the rule should be |
| | applied. |
| | Applies only for rules where time_of_day is set. |
| | Only one of interval and time_of_day can be set. |
| | DaysOfWeekEnumstring |
| | example: Sunday |
| | Days of the week. |
| retention | Integer |
| | Acceptable snapshot retention period in days. |
| list_of_policy_ids | String that identifies each policy group that utilizes |
| | this rule |

}

It should be understood that one or more of the properties and/or operations may be hidden from the standard user (i.e., not exposed to or accessible by the user) for simplification purposes. Furthermore, alternative formats, definitions, etc. are suitable for use as well.

In connection with replication, a user of a data storage array 24 may create one or more replication rules and apply each replication rule to a storage object. Replication rules are used for remote data protection. In particular, in response to each replication rule, the data storage array 24 creates a replication session to replicate the storage object to another data storage array 24 (e.g., the local data storage array 24(L) may replicate host data to the remote data storage array 24(R)). In some arrangements, a replication session replicates at a regular frequency both current data of a storage object as well as locally stored snapshots of the storage object. Each replication rule may be configured to create just one replication session or multiple sessions (e.g., 1-to-N, daisy chained sessions, etc.).

To apply a particular replication rule to a particular storage object, the data storage array 24 generates an association between the replication rule and the storage object. In some arrangements, the association includes a replication rule identifier that uniquely identifies the replication rule among other replication rules, a storage object identifier that uniquely identifies the storage object among other storage objects, and code that specifies the particular details of the replication rule. Such an association may be implemented in the form of a data structure, a database entry, an instance, combinations thereof, and so on.

Provided below is a suitable replication rule definition for each data storage array 24. Included are replication rule properties and supported replication operations such as creation, modification, and deletion. It should be understood that the user may need to initially enter certain information within the local data storage array 24 to enable the local data storage array 24 to properly identify and communicate with a remote data storage array 24 before creating and applying a replication rule.

replication_rule_instance{

| | |
|---|---|
| description: | Replication rule instance. |
| Id | string |
| | example: a9c64b58-59a5-45cd-80ed-92a4545fd080 |
| | Replication rule identifier. |
| Name | string |
| | example: Five minute RPO rule |
| | Replication rule name. |
| Rpo | RpoEnuminteger |
| | example: 5 |
| | Recover point objective (RPO). i.e., the interval |
| | between replication syncs, in minutes. |
| | Enum: |
| | Array [ 7 ] |
| io_priority | ReplicationIoPriorityEnumstring |
| | example: Low |
| | default: Medium |
| | IO priorities. |
| | Enum: |
| | Array [ 3 ] |
| remote_system_id | string |
| | Identifier of the remote system to which this rule |
| | will replicate associated objects. |
| list_of_policy_ids | String that identifies each policy group that utilizes |
| | this rule |

}

In addition to individually creating and applying data protection rules to storage objects, a user of a data storage array 24 may create a policy group that identifies (or includes) multiple data protection rules and then apply the policy group to one or more storage objects. When the user applies such a policy group to a storage object, the data storage array 24 responds by applying all of the data protection rules that belong to that policy group to that storage object at once. By applying the same policy group to multiple storage objects, the user is not burdened by meticulously and repetitively typing out the same data protection rules for each storage object.

To apply a particular policy group to a particular storage object, the data storage array 24 generates an association between that policy group and the storage object. In some arrangements, the association includes a policy group identifier that uniquely identifies the policy group among other policy groups, a storage object identifier that uniquely identifies the storage object among other storage objects, and code that specifies the particular details of the policy group (e.g., a list of data protection rule identifiers, the data protection rules themselves, combinations thereof, etc.). Such an association may be implemented in the form of a data structure, a database entry, an instance, combinations thereof, and so on.

Moreover, once the user has created a policy group, the user can modify and/or delete the policy group. When modifying a policy group, the user can add one or more data protection rules to the policy group, change one or more existing data protection rules currently within the policy group, and/or remove one or more data protection rules currently within the policy group. When the user saves (or executes) such a modification, the data storage array 24 is able to automatically apply the changes to each storage object that is associated with the modified policy group. Accordingly, the user does not need to repetitively make a similar change for each storage object that the policy group is assigned to.

Provided below is a suitable policy group definition for each data storage array 24. Included are a list of properties for the data protection policy. As mentioned above, a policy group can be created, modified, and deleted. Both snapshot rules and replication rules can be added to, changed, or removed from a policy group. When a policy group contains both snapshot and replication rules, application of the policy group to a storage object provides local and remote data protection to the storage object. However, a user may also create and apply policy groups that only include snapshot rules (e.g., for local data protection only), or only include replication rules (e.g., for remote data protection only), and so on.

policy_instance{

| | |
|---|---|
| description: | Policy instance. |
| id | string |
| | example: a9c64b58-59a5-45cd-80ed-92a4545fd080 |
| | Policy identifier. |
| name | string |
| | example: Gold Policy |
| | Policy name. |
| description | string |
| | Policy description. |
| list_of_rule_ids | String that identifies each rule in this policy group |

}

It should be understood that it is possible for a user to apply multiple data protection rules and/or policy groups to a storage object. In such a case, the data storage array 24 manages multiple associations that associate the multiple data protection rules and/or policy groups to that storage object.

It should be further understood that the data storage array 24 may delete (or de-associate) one or more data protection rules and/or policy groups to a storage object. In some arrangements, when the user deletes a data protection rule from a policy group, the data storage array 24 specifies a null data protection policy identifier within that policy group in place of an actual rule identifier.

Suitable identifiers include unique names, integers, alphanumeric strings, pointers, addresses, indexes, combinations thereof, and so on. Such identifiers enable the data storage arrays 24 to uniquely identify individual instances among other instances.

One should appreciate that there is no timing requirement regarding when the user creates a group of data collection policies and then applies that group to one or more storage objects. Along these lines, the user may wish to create and save several policy groups before applying any policy group and then, for each storage object under management, the user may selectively apply the created (or now predefined) policy groups to various storage objects.

Alternatively, the user may be working on a particular storage object (e.g., allocating memory to create that storage object) and, during the same working effort, create and apply a group of data collection policies to that particular storage object. Later, the user may apply that same policy group to one or more other storage objects.

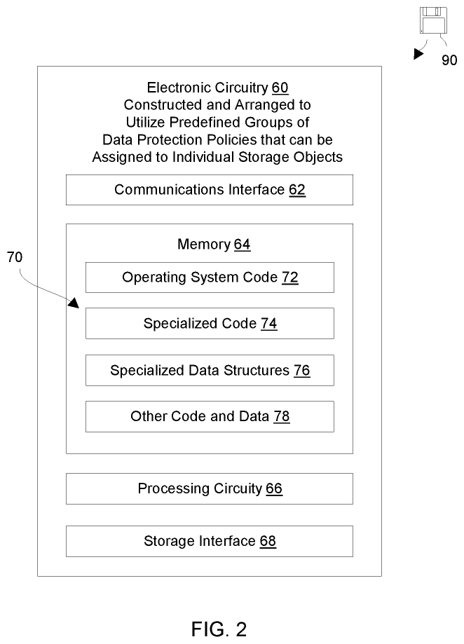

It should be understood that such creation and assignment of data protection rules and/or policy groups to storage objects are imposed on the data storage arrays 24 via a policy engine that responds to commands from a user. Such a policy engine may reside within one or more of the data storage arrays 24 (e.g., see the storage processing circuitry 40) and/or externally (e.g., see the other equipment 26). Further details will now be provided with reference to FIG. 2.

FIG. 2 shows specialized electronic circuitry 60 that is suitable for the storage processing circuitry 40 of each data storage array 24 (also see FIG. 1). The electronic circuitry 60 includes a communications interface 62, memory 64, and processing circuitry 66, and a storage interface 68.

The communications interface 62 is constructed and arranged to connect the electronic equipment 60 to the communications medium 28 (also see FIG. 1) to enable communications with other devices of the data storage environment 20 (e.g., the host computers 22). Such communications may be SAN-based, IP-based, cellular-based, cable-based, fiber-optic based, wireless, cloud-based, combinations thereof, and so on. Accordingly, the communications interface 62 enables the electronic equipment 60 to robustly and reliably exchange information with other external apparatus.

The memory 64 is intended to represent both volatile storage (e.g., DRAM, SRAM, etc.) and non-volatile storage (e.g., flash memory, magnetic memory, etc.). The memory 64 stores a variety of software constructs 70 including operating system code 72, specialized code 74, specialized data structures 76, and other code and data 78. The operating system code 72 is intended to refer to a kernel and other control instructions to manage computerized resources (e.g., processor cycles, memory space, etc.), drivers (e.g., an I/O stack), and so on. The specialized code 74 refers to instructions that enable utilization of data protection rules and policy groups that can be assigned to the individual storage objects (e.g., to form a policy engine). The specialized data structures 76 refers to a repository of entries (e.g., created and/or applied data protection rules and policy groups, assignments/associations, identifiers, etc.). The other code and data 78 refers to user-level applications, administrative tools, utilities, and so on. In some arrangements, storage devices 42 on a data storage array 24 (FIG. 1) may form at least a portion of the memory 64.

The processing circuitry 66 is constructed and arranged to operate in accordance with the various software constructs 70 stored in the memory 64. As will be explained in further detail shortly, the processing circuitry 66 executes the specialized code 74 and manages the specialized data structures 76 to effectively and efficiently enable a user to impose data protection on each storage object (e.g., apply a group of data protection policies to a storage object via a single operation, make policy group changes to automatically adjust data protection for multiple storage objects all at once, etc.). Such processing circuitry 66 may be implemented in a variety of ways including via one or more processors (or cores) running specialized software, application specific ICs (ASICs), field programmable gate arrays (FPGAs) and associated programs, discrete components, analog circuits, other hardware circuitry, combinations thereof, and so on. In the context of one or more processors executing software, a computer program product 90 is capable of delivering all or portions of the software constructs 70 to the electric circuitry 60. In particular, the computer program product 90 has a non-transitory (or non-volatile) computer readable medium which stores a set of instructions which controls one or more operations of the electric circuitry 60. Examples of suitable computer readable storage media include tangible articles of manufacture and apparatus which store instructions in a non-volatile manner such as CD-ROM, flash memory, disk memory, tape memory, and the like.

It should be understood that the processing circuitry 66, when operating in accordance with the software constructs 70 such as the specialized code 74, forms specialized circuitry that enables the user to effectively and efficiently utilize groups of data protection policies (e.g., to form a policy engine). To this end, the specialized circuitry may provide the user with a graphical user interface (GUI) from which to receive user input (e.g., user commands, parameters, etc.) as well as provide user output (e.g., status, feedback, etc.). One should appreciate that a variety of GUI techniques are suitable for use (e.g., via web browser, a custom interface, etc.).

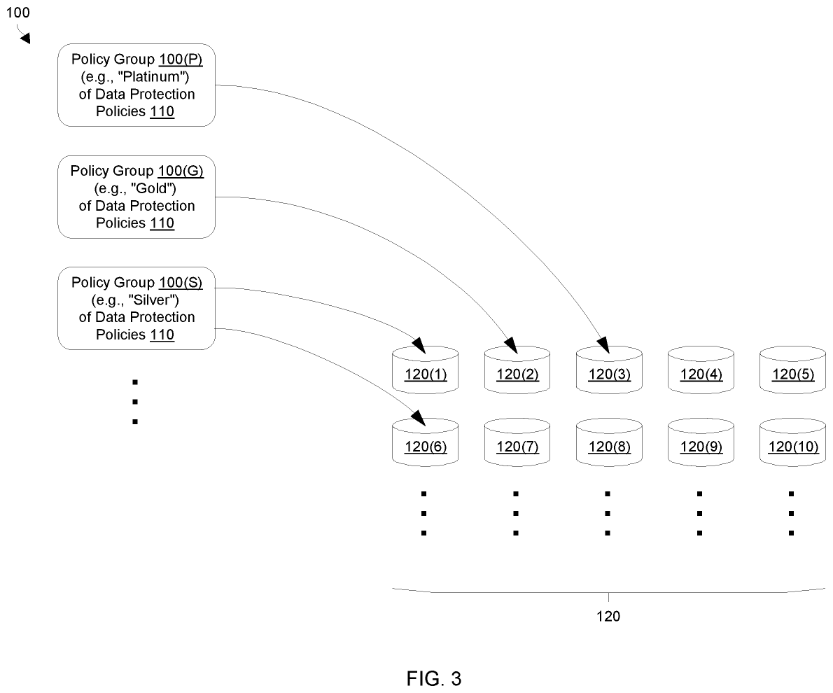

The storage interface 68 is constructed and arranged to communicate with the storage devices 42. Suitable protocols for the storage interface 68 include SATA, SAS, PCIe, combinations thereof, and so on. Further details will now be provided with reference to FIGS. 3 through 6.

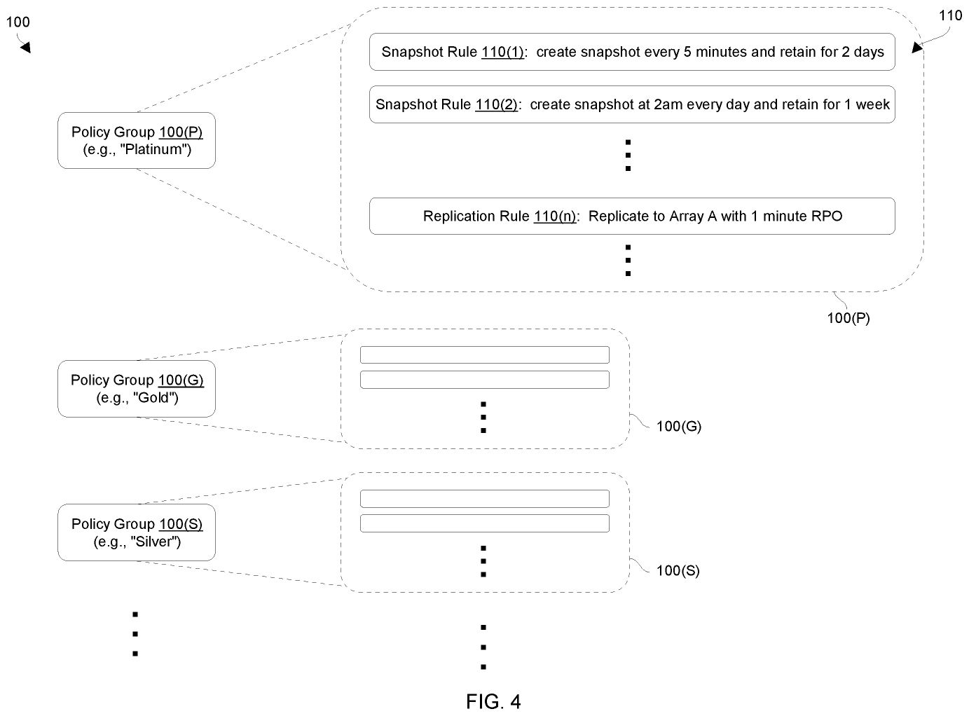

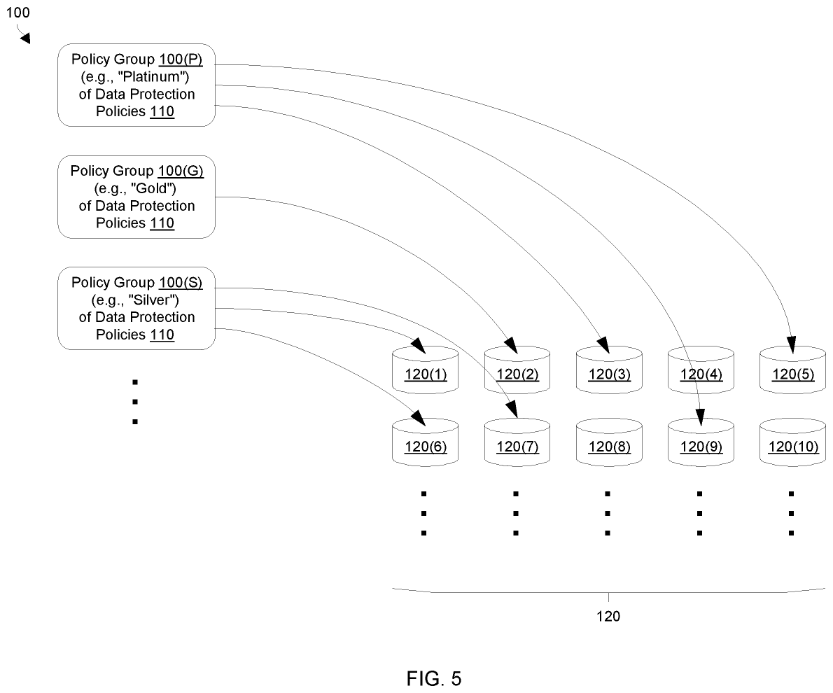

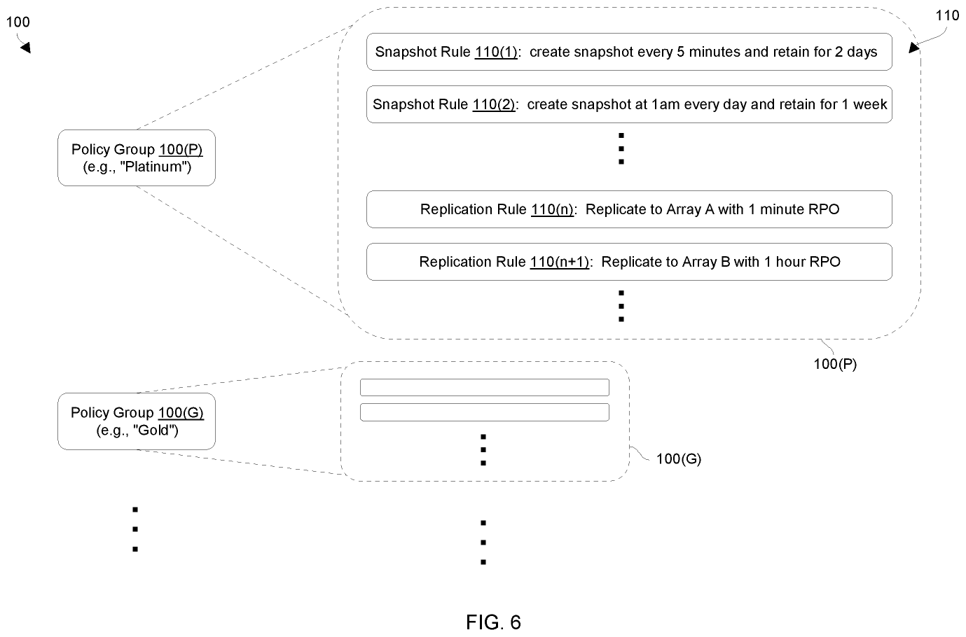

FIGS. 3 through 6 show various examples to illustrate particular features in accordance with certain embodiments. FIG. 3 shows particular details of an initial data storage situation. FIG. 4 shows further details of the example situation. FIG. 5 shows details of the example situation when a new assignment is made to a particular storage object. FIG. 6 shows details of the example situation when a change is made to a particular predefined group of data protection policies.

FIG. 3 shows an example situation in which a user of a data storage array 24 (also see FIG. 1) has created and saved different groups 100 of data protection policies 110, i.e., a “platinum” policy group 100(P), a “gold” policy group 100(G), a “silver” policy group 100(S), etc. As mentioned earlier, the user may create and save the policy groups 100 prior to assigning the policy groups to storage objects 120 of the data storage array 24. Alternatively, the user may create a new policy group 100 and assign that new policy group 100 to a particular storage object 120 on the fly.

When a user assigns a policy group 100 of data protection rules 110 to a storage object 120 (e.g., via a user command), a policy engine forms an association between that policy group and the storage object 120. From that point, the policy engine applies the data protection rules 110 of the policy group 100 to protect the data within the storage object 120.

By way of example only, the “platinum” policy group 100(P) has been assigned to the storage object 120(3). Accordingly, the data storage array 24 applies all of the data protection rules 110 that belong to the “platinum” policy group 100(P) to the storage object 120(3).

Additionally, by way of example only, the “gold” policy group 100(G) has been assigned to the storage object 120(2). As a result, the data storage array 24 applies all of the data protection rules 110 that belong to the “gold” policy group 100(G) to the storage object 120(2).

Furthermore, by way of example only, the “silver” policy group 100(S) has been assigned to the storage objects 120(1) and 120(6). Thus, the data storage array 24 applies all of the data protection rules 110 that belong to the “silver” policy group 100(S) to each of the storage objects 120(1) and 120(6). It should be appreciated that the user did not need to re-type the same data protection rules 110 for each of the storage objects 120(1) and 120(6) to give the storage objects 120(1), 120(6) the same data protection. Rather, the user was able to simply assign the same policy group 100(S) to each of storage objects 120(1) and 120(6) (e.g., via respective user commands).

FIG. 4 shows certain details of the policy groups 100. In particular, each policy group 100 identifies (or includes) one or more data protection rules 110. By way of example, the “platinum” policy group 100(P) identifies, perhaps among other data protection rules 110, a snapshot rule 110(1) to create a snapshot every 5 minutes and retain that snapshot for 2 days, a snapshot rule 110(2) to create a snapshot every at 2 am every day and retain that snapshot for 1 week, and replication rule 110(n) to replicate to another data storage array 24 (e.g., “Array A”) with a 1 minute RPO (recovery point objective).

It should be understood that the “platinum” policy group 100(P) may identify one or more other data protection rules 110 for snapshotting (e.g., in accordance with other time criteria) and one or more data protection rules 110 for replication (e.g., to replicate to another data storage array 24). Moreover, it should be understood that the other policy groups 100(G), 100(S), . . . may identify similar combinations and/or different combinations of data protection rules 110.

At this point, it should be clear that when a policy group 100 is assigned to a storage object 120, the data storage array 24 applies all of the data protection rules 110 that are identified by that policy group 100 to that storage object 120. Accordingly, since “platinum” policy group 100(P) is assigned to the storage object 120(3), data storage array 24 applies all of the above-mentioned data protection rules 110 identified by the “platinum” policy group 100(P) to the storage object 120(3).

FIG. 5 shows the example situation of FIG. 3 after the user has further assigned certain earlier created and saved (i.e., now predefined) policy groups 100 to other storage objects 120 of the data storage array 24. To this end, the user has entered input into a GUI to modify the operation of the data storage array 24.

Recall that the “platinum” policy group 100(P) was initially assigned only to the storage object 120(3) (also see FIG. 3). By way of example only, the user has further assigned the “platinum” policy group 100(P) to the storage objects 120(5) and 120(9). Along these lines, the user may enter a single command (e.g., via a GUI) to assign the “platinum” policy group 100(P) to the storage object 120(5). Likewise, the user may enter another single command to assign the “platinum” policy group 100(P) to the storage object 120(9). One should appreciate that, with each single command, the user is able to assign all of the data protection rules 110 identified by the “platinum” policy group 100(P) to a particular storage object 120. Such a task is less burdensome and prone to error than a task of the user individually typing in and assigning each data protection rule 110 to each storage object 120 one by one. That is, in response to a single policy group assignment command from the user, a policy engine controlling the data storage array 24 associates the “platinum” policy group 100(P) with a particular storage object 120 (e.g., the storage object 120(3) or the storage object 120(9)). In response, the data storage array 24 applies the particular data protection rules 110 (FIG. 4) of the “platinum” policy group 100(P) to that storage object 120 (also see FIG. 4).

Likewise, recall that the “silver” policy group 100(S) was initially assigned only to the storage objects 120(1) and 110(6) (also see FIG. 3). By way of example only, the user has further assigned the “silver” policy group 100(S) to the storage object 120(7). Such assignment directs the data storage array 24 to now associate the “silver” policy group 100(S) with the storage object 120(7) in addition to earlier-formed associations with the storage objects 120(1) and 120(6). In response, the data storage array 24 now further applies the multiple data protection rules 110 identified by the “silver” policy group 100(S) (FIG. 4) to the storage object 120(7).

FIG. 6 shows the example situation after the user has made a policy group modification. By way of example, the user has modified the “platinum” policy group 100(P). In particular, the user has changed the data protection rule 110(2) of the policy group 100(P) so that a snapshot is now created at 1 am every day rather than 2 am every day. Additionally, by way of example, the user has added another data protection rule 110(n+1) to the policy group 100(P) (i.e., the user has modified the policy group 100(P) to identify another data protection rule 110) so that replication is made to another data storage array 24 (e.g., Array B) with a 1 hour RPO.

When the user commits the modification to the “platinum” policy group 100(P), the data storage array 24 applies the modification to each storage object 120 that the “platinum” policy group 100(P) is assigned to. Such operation thus enables the user to update data protection to multiple storage objects 120 all at once (e.g., to storage objects 120(3), 120(5), and 120(9) simultaneously).

In some situations, the modification may be automatic and applied immediately. For example, suppose that the modification includes reducing the snapshot retain period for certain snapshots from 2 days to 1 day (also see the data protection rule 110(1) in FIG. 4). Such an automatic and immediate application may quickly free up certain resources of the data storage array 24 such as non-volatile memory thus improving the operation of the data storage array 24.

In other situations, the data storage array 24 may prompt the user with the storage objects 120 that the “platinum” policy group 100(P) is assigned to (e.g., via the GUI in the form of a list) and enables the user to apply the “platinum” policy group 100(P) to the storage objects 120 selectively based on further user input. For example, the data storage array 24 may allow the user to save the modified policy group 100 as a new policy group 100 (e.g., a “bronze” policy group 100) and apply the new policy group 100 only to storage objects 120 that the user selects. In such a situation, the original policy group continues to apply to the non-selected storage objects 120.

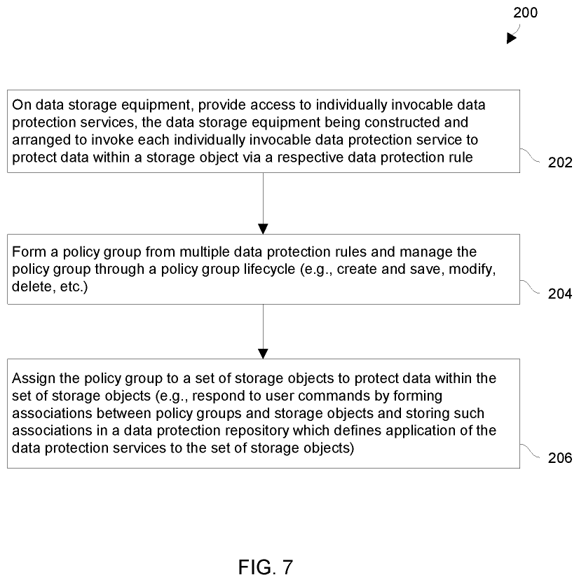

Other policy group modifying methodologies are suitable for use as well. Moreover, in addition to changing and adding one or more data protection rules 110 to a policy group 110, the user may delete one or more data protection rules 110 from a policy group. Such operations enable the user to update data protection to multiple storage objects 120 without any need to separately change data protection rules 110 assigned to each storage object 120 individually. Further details will now be provided with reference to FIG. 7.

FIG. 7 is a flowchart of a procedure 200 which utilizes a group of data protection policies within data storage equipment. The procedure 200 may be performed by a policy engine that imposes data protection on one or more data storage arrays 24. The policy engine may reside with the data storage arrays 24 or be external to the data storage arrays 24.

At 202, the policy engine provides access to individually invocable data protection services. Recall that the data storage arrays 24 are constructed and arranged to invoke each individually invocable data protection service to protect data within a storage object via a respective data protection rule.

At 204, the policy engine forms a policy group from multiple data protection rules. Along these lines, the policy engine creates and saves a policy group that identifies (or includes) multiple data protection rules. At this point, the policy group is assignable to one or more storage objects. Additionally, the policy group may be managed through a policy group lifecycle (e.g., the policy group may be modified, re-assigned, deleted, and so on).

At 206, the policy engine assigns the policy group to a set of storage objects to protect data within the set of storage objects. Here, the policy engine may response to user commands by forming associations between policy groups and storage objects and saving such associations in a data protection repository. Such a data protection repository may define how the various data protection services are applied to the set of storage objects (e.g., also see the specialized data structures 76 in FIG. 2).

As described above, improved techniques are directed to utilizing groups 100 of data protection policies (or rules) 110 that are assignable to storage objects 120 (e.g., logical units of storage or LUNs, file systems, etc.). In particular, a user can simply assign a policy group 100 to each storage object 120. The policy group 100 may include a variety of data protection policies 110 such as one or more snapshot rules and one or more replication rules. Accordingly, the user is able to impose an entire group 100 of data protection policies 110 on each storage object 120 all at once. Moreover, the user may change a policy or policies 110 within a policy group 100 that is assigned to multiple storage objects 120 and thus adjust data protection policies 110 for the multiple storage objects 120 all at once. As a result, there is less time and effort imposed on the user compared to a human system administrator's conventional task of manually configuring each volume or file system individually. Furthermore, there is no special script writing skills required by the user thus making the user's job less complicated and less prone to error.

One should appreciate that the above-described techniques do not merely collect, store, and analyze data. Rather, the disclosed techniques involve an improvement to the technology. Along these lines, with the above-described techniques, a data storage array 24 enjoys robust and reliable data protection of one or more storage objects 120 based on specialized constructs, i.e., policy groups 100 where each policy group 100 is able to identify multiple data protection rules 120. Moreover, if a policy group 100 is assigned to multiple storage objects 120, any change to the policy group 110 invokes a change to each storage object 120 thus alleviating the need to separately make a change to the individual rules 110 applied to each storage object 120. Such changes to how the data storage array operates improves data storage array organization and efficiency.

While various embodiments of the present disclosure have been particularly shown and described, it will be understood by those skilled in the art that various changes in form and details may be made therein without departing from the spirit and scope of the present disclosure as defined by the appended claims.

For example, it should be understood that various components of the data storage environment 20 such as the host computers 22 are capable of being implemented in or “moved to” the cloud, i.e., to remote computer resources distributed over a network. Here, the various computer resources may be distributed tightly (e.g., a server farm in a single facility) or over relatively large distances (e.g., over a campus, in different cities, coast to coast, etc.). In these situations, the network connecting the resources is capable of having a variety of different topologies including backbone, hub-and-spoke, loop, irregular, combinations thereof, and so on. Additionally, the network may include copper-based data communications devices and cabling, fiber optic devices and cabling, wireless devices, combinations thereof, etc. Furthermore, the network is capable of supporting LAN-based communications, SAN-based communications, combinations thereof, and so on.

One should appreciate that, in accordance with certain embodiments, a user defined policy can be used to protect multiple storage resources on a single storage array. Both local and remote protection rules can be defined in a policy. Once a policy is applied to a storage resource, the resource is automatically protected locally with regularly scheduled snapshots based on the local snap rules, and remotely via replication sessions that are created by the policy engine based on the remote replication rules. The replication sessions replicate local storage data changes to one or more remote arrays at recovery point objective (RPO) intervals as defined in the remote replication rules.

In accordance with certain embodiments, a policy includes multiple snap and replication rules. Each snap rule can be used to define a snapshot schedule with an hourly interval or once a day schedule at a certain time of the day. Snapshot retention periods can also be added to each snap rule. Each replication rule consists of a RPO interval and a remote array. Multiple replication rules can be added to a policy to support 1-to-N fan out replication configuration.

After a policy with a replication rule is applied to a local resource, a policy orchestration engine creates (i) a peer resource on the remote array, and (ii) a replication session on both the local and remote arrays to capture the peer relationship between the local storage resource and the remote resource on the peer array. Data is synchronized from the local array to the remote array on an interval cadence defined by the RPO in the replication rule.

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

In some situations, each data storage array 24 manages and provides data protection for both block-based and filed-based storage objects 120. Moreover, in some situations, a data storage array 24 manages production data on behalf of a set of host computers 22 as well as replicated data on behalf of a set of other data storage arrays 24.

Additionally, in some arrangements, data protection rules can be applied directly to storage objects. In other arrangements, data protection rules are applied indirectly to storage objects (e.g., via associations) which are managed by a policy engine.

Furthermore, it should be understood that the above-described data protection rules and policy groups may be un-assigned from storage objects. For example, if a storage object is to be deleted, a user may un-assign all rules and/or policy groups from the storage object before deleting the storage object. Similarly, if certain data protection is no longer needed for a storage object, the user may un-assign a particular rule and/or policy group from that storage object to remove that data protection. Such modifications and enhancements are intended to belong to various embodiments of the disclosure.

What is claimed is:

1. A method of utilizing a group of data protection policies within data storage equipment, the method comprising:
providing, by the data storage equipment, access to individually invocable data protection services, the data storage equipment being constructed and arranged to individually invoke each individually invocable data protection service in response to user entrance of a respective data protection rule to protect data within a storage object;
forming, by the data storage equipment, a policy group from multiple data protection rules; and
assigning, by the data storage equipment, the policy group to a set of storage objects to protect data within the set of storage objects.

2. A method as in claim 1 wherein the policy group identifies different data protection rules; and
wherein assigning the policy group to the set of storage objects includes:
applying each of the different data protection rules identified by the policy group to a particular storage object.

3. A method as in claim 2 wherein applying each of the different data protection rules identified by the policy group includes:
applying multiple snapshot rules to protect data of the particular storage object locally, each of the multiple snapshot rules specifying a different snapshot creation schedule to routinely create snapshots of the particular storage object on a local data storage array.

4. A method as in claim 2 wherein applying each of the different data protection rules identified by the policy group includes:
applying multiple replication rules to protect data of the particular storage object remotely, each of the multiple replication rules specifying a different replication session to replicate the particular storage object to a remote data storage array.

5. A method as in claim 2 wherein applying each of the different data protection rules identified by the policy group includes:
(i) applying at least one snapshot rule to protect data of the particular storage object locally and (ii) applying at least one replication rule to protect data of the particular storage object remotely,
each snapshot rule specifying a particular snapshot creation schedule to routinely create snapshots of the particular storage object on a local data storage array; and
each replication rule specifying a particular replication session to replicate the particular storage object to a remote data storage array that is different from the local data storage array.

6. A method as in claim 5 wherein applying at least one snapshot rule to protect data of the particular storage object locally includes:
invoking a first snapshot rule to create a first series of snapshots of the particular storage object on the local data storage array in accordance with first time criteria, and
invoking a second snapshot rule to create a second series of snapshots of the particular storage object on the local data storage array in accordance with second time criteria that is different from the first time criteria.

7. A method as in claim 6 wherein applying at least one replication rule to protect data of the particular storage object remotely includes:
invoking a first replication rule to replicate the particular storage object to a first remote data storage array, and
invoking a second replication rule to replicate the particular storage object to a second remote data storage array that is different from the first remote data storage array.

8. A method as in claim 1 wherein the policy group identifies different data protection rules; and
wherein assigning the policy group to the set of storage objects includes:
applying each of the different data protection rules identified by the policy group to a first storage object residing in non-volatile memory of a local data storage array and a second storage object residing in the non-volatile memory of the local data storage array, the first storage object being different from the second storage object.

9. A method as in claim 8 wherein applying each of the different data protection rules to the first storage object and the second storage object includes:
in response to a first user command, applying each of the different data protection rules to the first storage object during a first time period to protect data of the first storage object locally and remotely during the first time period,
after the first time period, receiving a second user command, and
after the first time period and in response to the second user command, applying each of the different data protection rules to the second storage object during a second time period that is after the first time period to protect data of the second storage object locally and remotely during the second time period, the different data protection rules continuing to be applied to the first storage object during the second time period to protect data of the first storage object locally and remotely during the second time period.

10. A method as in claim 9 wherein the local data storage array is constructed and arranged to process block-based input/output (I/O) requests on behalf of a set of host computers;
wherein the first storage object is a first logical unit of storage (LUN) that stores host data based on the block-based I/O requests; and
wherein the second storage object is a second LUN that stores host data based on the block-based I/O requests, the second LUN being different from the first LUN.

11. A method as in claim 9 wherein the local data storage array is constructed and arranged to process file-based input/output (I/O) requests on behalf of a set of host computers;
wherein the first storage object is a first file system that stores host data based on the file-based I/O requests; and
wherein the second storage object is a second file system that stores host data based on the file-based I/O requests, the second file system being different from the first file system.

12. A method as in claim 9, further comprising:
after the second time period, receiving a third user command, and
in response to the third user command, making a data protection rule modification to the policy group.

13. A method as in claim 12 wherein making the data protection rule modification to the policy group includes:
changing at least one data protection rule identified by the policy group while the policy group is being applied to the first storage object and the second storage object.

14. A method as in claim 13, further comprising:
in response to changing a particular data protection rule identified by the policy group while the policy group is being applied to the first storage object and the second storage object, immediately applying the changed particular data protection rule to the first storage object and the second storage object.

15. A method as in claim 13, further comprising:
in response to changing a particular data protection rule identified by the policy group while the policy group is being applied to the first storage object and the second storage object, immediately prompting a user for permission to apply the changed particular data protection rule to the first storage object and the second storage object.

16. A method as in claim 9 wherein an original policy group is assigned to the first storage object and the second storage object during the second time period; and
wherein the method further comprises:
after the second time period, receiving a third user command, and
in response to the third user command, assigning a new policy group to one of the first storage object and the second storage object in place of the original policy group while the original policy group remains assigned to the other of the first storage object and the second storage object, the original policy group and the new policy group differing in at least one data protection rule.

17. A method as in claim 9, further comprising:
after the second time period, receiving a third user command, and
in response to the third user command, retrieving data that was protected in response to application of the policy group to the first storage object and the second storage object.

18. Data storage equipment, comprising:
memory; and
control circuitry coupled to the memory, the memory storing instructions which, when carried out by the control circuitry, cause the control circuitry to:
provide access to individually invocable data protection services, the data storage equipment being constructed and arranged to individually invoke each individually invocable data protection service in response to user entrance of a respective data protection rule to protect data within a storage object,
form a policy group from multiple data protection rules, and
assign the policy group to a set of storage objects to protect data within the set of storage objects.

19. A computer program product having a non-transitory computer readable medium which stores a set of instructions to utilize a group of data protection policies within data storage equipment; the set of instructions, when carried out by the data storage equipment, causing the data storage equipment to perform a method of:
providing access to individually invocable data protection services, the data storage equipment being constructed and arranged to individually invoke each individually invocable data protection service in response to user entrance of a respective data protection rule to protect data within a storage object;
forming a policy group from multiple data protection rules; and
assigning the policy group to a set of storage objects to protect data within the set of storage objects.
